(19) United States
(12) Patent Application Publication
(10) Pub. No.: US 2015/0315762 A1
(43) Pub. Date: Nov. 5, 2015

(54) PROCESS FOR APPLYING COATINGS TO PILINGS

(71) Applicant: Thunderbolt Wood Treating, Inc., Riverbank, CA (US)

(72) Inventors: Leonard Lovalvo, Riverbank, CA (US); Grace Lovalvo, Riverbank, CA (US)

(21) Appl. No.: 14/704,790

(22) Filed: May 5, 2015

Related U.S. Application Data
(60) Provisional application No. 61/988,529, filed on May 5, 2014.

(51) Int. Cl. E02D 5/60; B05D 1/02; B62B 3/10; B05D 7/06; B05D 3/00; E02D 31/00; B05D 3/12

(52) U.S. Cl. CPC E02D 5/60; E02D 31/00; B05D 1/02; B05D 3/12; B05D 7/06; B05D 3/002; B62B 3/102

(57) ABSTRACT

A piling is supported substantially horizontally upon a carrier including at least two pairs of roller wheels on at least two separate bases spaced from each other and with the piling resting upon the roller wheels. A two part spray head mixes and sprays a coating material, such as a PTMEG type material, onto a lateral surface of the piling. Elongate spray passes are followed by partial rotation of the piling upon the roller wheels and further spray passes until a full layer of coating is applied. After early layers of coating material have been applied to the piling, a squeegee is passed longitudinally against the surface while pressing against the surface, to cause a tight bond. Thereafter, additional layers of coating material are applied to achieve the desired thickness for the overall coating. Finally, the outermost surface is worked with a squeegee to produce a desired surface finish.

### CROSS-REFERENCE TO RELATED APPLICATIONS

This application claims benefit under Title 35, United States Code §119(e) of U.S. Provisional Application No. 61/988,529 filed on May 5, 2014.

### FIELD OF THE INVENTION

The following invention relates to methods for coating of elongate structures. More particularly, this invention relates to methods for coating elongate structures such as pilings while utilizing a spray head to spray coating material onto the elongate structure in layers, and also including working of the material coating layers physically at least somewhat.

### BACKGROUND OF THE INVENTION

Marine pilings are used in a variety of different marine environments to provide structural support for docks, piers and other coastline physical structures. The pilings are generally characterized by having a cylindrical form which has dimensions which are exceptionally longer than their diameter. For instance, pilings can range in length from dozens of feet to well over one hundred feet in length.

The material from which pilings are typically formed is some type of wood. In a typical example, Douglas Fir wood is effectively utilized. The piling is formed from the entire trunk of the tree in a typical embodiment, which trunk has been de-limbed and debarked. Other finishing of the surface of the wood might include some degree of shaping of the outer cylindrical surface, cutting to length, and potentially treating, such as pressure treating, as is known in the art. The pilings are also characterized in that they have a slightly greater diameter at one end than the other end. The smaller diameter end is typically placed downward and the piling is driven into the ground at a desired location to a desired depth based on structural and engineering requirements at the site. Other portions of the structure are mounted in a variety of different ways to upper ends of the pilings.

Because significant mid-portions of the pilings come in direct contact with the water (and typically salt water of the marine environment) unique difficulties are presented. The marine environment is harsh on the piling, causing the piling to diminish in structural strength over time. Depending on how the wood material is treated, these treatments can pose a hazard to the marine environment, such as by harmful chemicals leaching into the water and causing harm to marine life.

In the prior art, piling systems have had to be designed in a manner striking a balance between these difficulties to achieve a piling structure which has an acceptably long life with the desired structural strength, while also avoiding damage to the marine environment. Furthermore, the marine environment where pilings are utilized often involves significant amounts of boating traffic. This boating traffic can include very large seagoing vessels in many instances. These vessels exert significant forces on the pilings themselves when the pilings are impacted by such vessels, such as when the vessel is docking adjacent a structure in which the pilings are incorporated, and also from wave and tidal action which causes vessels to move against pilings.

Such abrasive and impact loads on the surface of the pilings provide another source of damage to the pilings, both from individual incidents and over time. Such impact damage also presents further opportunity for materials associated with the pilings to enter into the marine environment and exacerbate any damage which might be caused to the marine environment, such as by leaching of pressure treating chemicals into the marine environment after impact loads are encountered against the surface of the pilings.

One piling which has been effective in balancing these difficulties and producing a piling of both long life and environment hazard avoidance is a piling which has been coated with a sufficiently thick layer of a polyurea solid coating. Such coatings act to encapsulate any pressure treating materials to which the wood has been subjected and provide a resilient outer surface which can deflect impact loads of at least a low and moderate level. While such coated pilings can be coated with a variety of different materials, one material which has been found to be exceptionally desirable is polytetramethylene ether glycol, known by the acronym PTMEG. Such PTMEG coated pilings have found themselves to be the product of choice for many designers seeking to maximize piling strength and longevity, as well as environmental hazard avoidance.

The PTMEG is a two component polyurea elastomer coating which has been in existence since the mid-1980s. Such polyurea systems have sometimes been characterized as modified two component polyurethane systems. While they both may have some characteristics in common, polyurea systems are actually a unique technology from polyurethane systems.

Two component polyurea systems are typically known for a very rapid dry time (typically less than thirty seconds), achieved without the use of a catalyst, as is required with two component polyurethane systems. This rapid dry time is very consistent/uniform over a broad ambient temperature range. While the fast reaction/rapid dry time is virtually unaffected by ambient moisture, the presence of a moisture on a substrate must be considered when achieving adhesion to that substrate. This is all made possible by unique chemistry of raw materials used to develop the two component polyurea systems. Two component fast set polyurea systems typically do not contain any solvents or volatile organic compounds (VOCs).

Polyurea systems with a slower/modified reactivity and set time when used in spray application generally provide better wetting and adhesion to the substrate, such as a piling surface. These systems are also used in concrete joint filling applications. The main distinguishing characteristic with the polyurea technology over polyurethanes is that amine terminated (—NH2) resins are used rather than hydroxyl terminated (—OH) resins, commonly referred to as polyols. The reaction of the amine terminated resins with the isocyanate component results in the formation of a urea linkage. Since this is a polymer and these units repeat, the term polyurea then applies. The basic reaction to form the polyurea involves combining an isocyanate prepolymer with polyamine to produce the polyurea polymer. The resulting polyurea physical properties result in highly desirable characteristics for the coating of pilings, such as described above.

For such a PTMEG coated piling to have the very best performance, it is important that a strong bond be provided between the PTMEG polyurea coating and the underlying wood material. It is also desirable that a relatively smooth outer surface be provided. It is also desirable that the PTMEG coating be of substantially uniform thickness. Furthermore, difficulties can be encountered during the PTMEG application process due to the unique manner in which the PTMEG needs to be handled and applied. Accordingly, a need exists for a process for applying coatings to pilings such as PTMEG so that a piling having optimal performance characteristics can be provided, and in a manner which can efficiently be performed in a safe and economical fashion.

### SUMMARY OF THE INVENTION

With this invention, a process is defined for applying a coating such as PTMEG to pilings or other elongate wood structural elements. Initially, a piling or other elongate wood structure is identified which is to receive the coating of PTMEG or other similar material. When similar materials to PTMEG are referred to, those materials which require spray application as well as some physical working of the material surface are considered to be in this category and benefit from the process of this invention. The wood material is selected having a moisture content of less than 19% to 22%. The wood can be treated or untreated and still be usable according to this invention. If the wood is not sufficiently dry, the wood can be dried before performing this process. While Douglas fir is one acceptable wood material, other woods or wood-like elongate structures could similarly be utilized according to the process of this invention.

Initially, the wood is inspected for splinters and any other debris adhering thereto. The wood is cleaned to remove splinters, such as with a wire brush. The wood is also preferably blasted with compressed air to further remove debris and loose wood fibers from the outer surface.

An inspection step is next performed to identify large checks or cracks within the piling. Any large checks or cracks are filled in advance of the PTMEG coating process. Such filling can involve filling with caulk or covering with tape. Small cracks and other imperfections are effectively filled with the PTMEG coating and do not need to be filled or covered. When the wood material has been appropriately prepped by having been cleaned, inspected and any checks/cracks filled or covered, the wood material is ready for coating.

The wood material is preferably supported upon rollers to allow the elongate structure to be effectively positioned within a coating environment. The coating environment is preferably an enclosed housing, such as a building having dimensions sufficient to accommodate the length of the piling or other elongate wooden material to be coated. To manage such positioning, a pair of carriers are preferably provided. The carriers include a base with a pair of support wheels extending up from an upper surface of the base, with the pair of wheels in a common plane generally perpendicular to a longitudinal axis of the piling. The base can be supported upon caster wheels so that the carriers can be moved about with the elongate piling supported thereon. The caster wheels or other supports can be locked in position once the piling is positioned where desired. Because the piling is supported upon a pair of wheels over each carrier, the piling is held in fixed location but can have its orientation rotated about its longitudinal axis (about arrow B of FIG. 1). While two carriers are shown in FIG. 1, more than two carriers could be utilized if needed, such as for exceptionally long pilings.

Before the first coat of coating material, such as PTMEG, is applied, the coating material application spray equipment is prepped for operation. This preparation includes calculating how much coating material is likely to be required based on square footage of the surface of the piling and the number of layers of material to be applied, as well as the thickness of the layers of material. Spray equipment is checked to make sure that a sufficient amount of material is ready for application. The spray equipment is configured to be of a type which can both heat the material to be applied and also combine two separate components of the material together, such as in a one-to-one ratio, before being sprayed from the equipment. The spray equipment thus includes some means for heating the material and keeping it at a minimum temperature (typically at least 175° F.). The spray equipment also is configured to pressurize the spray to approximately 3,000 psi. Most preferably, the two separate components of the PTMEG are routed from heated pressurized separate supplies to a combining spray nozzle, and not combined until they reach the spray nozzle.

A first layer of PTMEG material is then sprayed onto the elongate piling or other wood structure to be coated. Each layer of PTMEG involves passing a spray head along a longitudinal axis from a first end to a second end. The piling or other structure is then rotated, such as 90° and the coating of the first layer continues. After the piling has been rotated and passes of spray have been applied so that all of the surface of the piling has received a first coat, the first layer is complete. After this first layer is complete, a second layer is applied upon the first layer in the same fashion that the first layer was applied.

After two coats have been applied, a squeegee is mechanically brought into contact with the surface of the piling and passed along the surface of the piling longitudinally. These passes of the squeegee occur from a first end to a second end, followed by turning of the piling and then again passing along the surface of the piling until all of the PTMEG material has had the squeegee pressed there against. The squeegee is passed over the surface in a manner applying force against the outer surface of the PTMEG, tending to press the PTMEG into the wood somewhat. This squeegee action assists in strengthening the bond between the PTMEG coating and the outer surface of the wood.

A visual inspection after the squeegee procedure will determine whether cracks of a small variety that were not filled are being effectively filled by the PTMEG. If not, further squeegeeing can occur until such cracks are no longer visible. Furthermore, if bubbles appear in the PTMEG during the squeegee process, these bubbles can be inspected to ensure that no bare wood is exposed inside the bubbles (and if so the squeegee work can continue to avoid any exposed wood remaining).

After this initial squeegeeing procedure has been completed over the entire surface of the piling, further layers of PTMEG are applied in the same fashion that the first layer and second layer were applied. In a typical embodiment, twelve total layers of PTMEG are sequentially applied to the outer surface of the piling or other elongate wood structure. The number of coats could vary based on specifications called for by a designer. After the final layer of PTMEG has been applied, the squeegee is again used in a process similar to that described above, except to provide a smooth final finish surface for the coated piling free from any discernible surface imperfections.

If multiple pilings or other structures are to be coated, another piling can be brought into position and coated with PTMEG in the same manner as the first, by following the same procedure. The piling which has already been coated can be left to have the PTMEG coating cool and cure into its final surface finish. It is then ready to be transported to a desired location for use. Finally, spray equipment can be shut down in a manner which is consistent with operating instructions for the spray equipment and to keep the spray equipment sufficiently clean and prepped for reuse in the future.

### OBJECTS OF THE INVENTION

Accordingly, a primary object of the present invention is to provide a method for applying a coating such as PTMEG to an outer surface of an elongate structure such as a piling with the coating having a secure bond to the surface of the piling.

Another object of the present invention is to provide a method for applying a coating such as PTMEG or similar material as a coating to an outer surface of an elongate structure such as a piling with the coating having a smooth outer surface.

Another object of the present invention is to provide a method for applying a coating, such as PTMEG, to an outer surface of an elongate structure such as a piling with the coating having a desired thickness made up of multiple individual layers.

Another object of the present invention is to provide a coating for pilings which protects the piling from damage and corrosion.

Another object of the present invention is to provide a method for coating a piling which simplifies the coating process and avoids damage to the piling, coating equipment or danger to personnel applying the coating.

Another object of the present invention is to provide a piling coating method which is suitable for coating exceptionally long pilings, including pilings as long as one hundred feet long or more.

Other further objects of the present invention will become apparent from a careful reading of the included drawing figures, the claims and detailed description of the invention.

### BRIEF DESCRIPTION OF THE DRAWINGS

FIG. 1 is a perspective view of a portion of a platform, such as a dock, with the platform supported upon pilings such as coated pilings according to this invention and illustrating one form of elongate structure to be coated according to a method of this invention.

FIG. 2 is a perspective view of a piling or other elongate structure such as a wood core for a piling, supported upon rollers/carriers during a piling coating method of this invention, and with the piling shown in broken lines.

FIG. 3 is a perspective view of an end of the piling after it has been coated, and with a portion of the coating cut away to reveal a cross-section of the coating of the piling.

FIG. 4 is a perspective view of a portion of that which is shown in FIG. 2 and illustrating movement of the piling during the coating procedure, as well as orientation of a spray head and squeegee during various different steps in the piling coating process.

FIG. 5 is a perspective view of a squeegee with an arcuate blade for use in the process of this invention as one working tool to enhance a bond between the coating and the surface of the piling and to improve a surface finish of the coated piling.

### DESCRIPTION OF THE PREFERRED EMBODIMENT

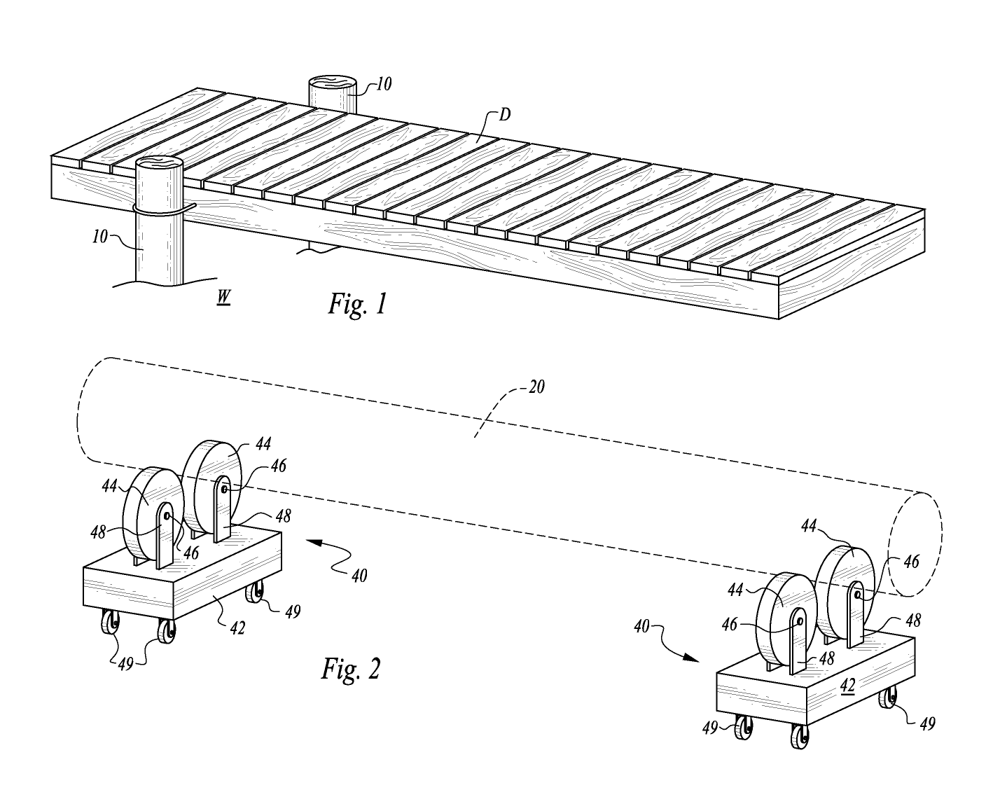

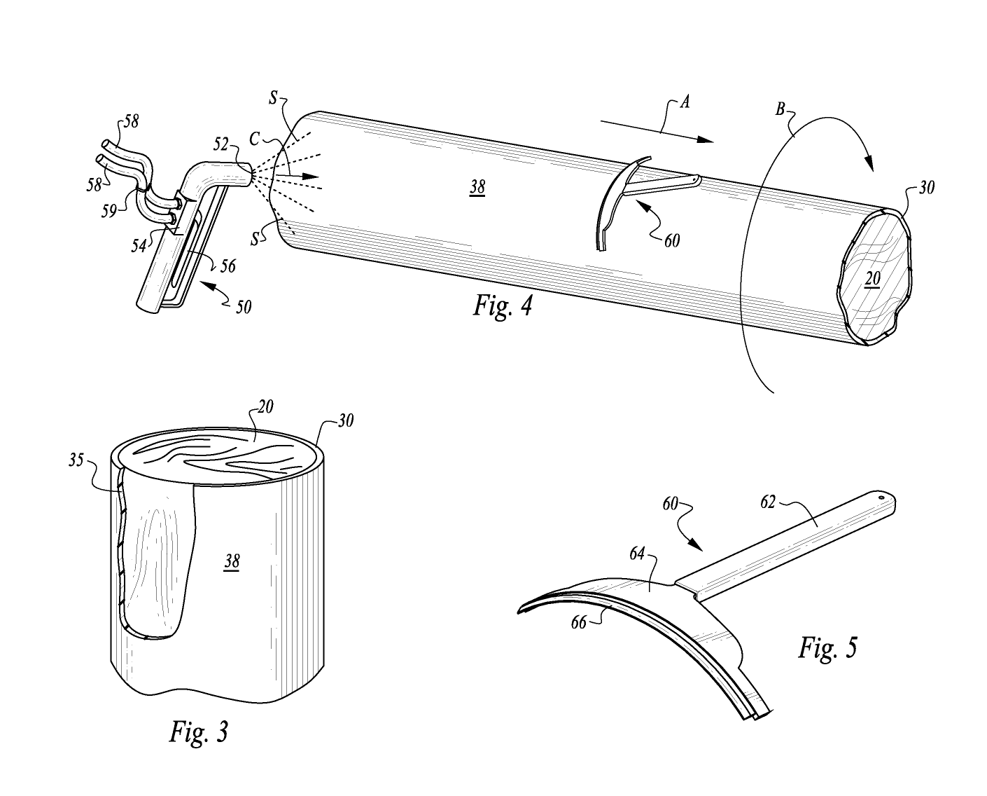

Referring to the drawings, wherein like reference numerals represent like parts throughout the various drawing figures, reference numeral 10 is directed to a coated piling such as that which can be used in a marine environment, such as to support a dock D or other platform in a marine environment (FIG. 1). Other elongate structural members or other items can also be coated, especially with PTMEG, or other similar coatings, according to the method of this invention.

In essence, and with particular reference to FIGS. 2 and 4, basic details of the coated piling 10 and method for coating the piling 10 are described, according to a preferred embodiment. A wood core 20, for such as a piling is initially provided without a coating 30. This outer coating 30 is applied according to a method of this invention by placing the wood core 20 upon a set of at least two carriers 40. Each carrier 40 rotatably supports the wood core 20 thereon. A spray head 50 is placed proximate to the outer surface of the wood core 20 and a layer of PTMEG (or other similar material) is sprayed onto an outer surface of the wood core 20. The spray head 50 is moved longitudinally (along arrow A of FIG. 4) to apply a coating to the wood core 20. After a pass of the spray head 50 from one end to the other, the wood core 20 is rotated (along arrow B of FIG. 4) to present a portion of the wood core 20 outer surface which has not yet received a layer of the outer coating 30. The passage of the spray head 50 then continues to occur (along arrow A) to complete this first layer of the outer coating 30. A squeegee 60 is also used by pressing against layers of the outer coating 30, typically early in the process to enhance a bond between layers of the outer coating 30 and the outer surface of the wood core 20, and to provide a smooth outer surface 38 of the outer coating 30 at an end of the coating process.

More specifically, and with continuing reference to FIGS. 2 and 4, specific details of the coated piling 10 and process for coating the coated piling 10 are described, according to a preferred embodiment of this invention. The coated piling 10 includes the wood core 20 with an outer coating 30 of PTMEG or similar material. The wood core 20 is an elongate linear structure formed by delimbing and debarking the trunk of a tree, and particularly a tree which is predisposed toward growing straight and tall. One such tree would be a douglas fir tree. The wood core 20 would typically have some degree of taper built thereinto with the smaller diameter at a lower end and a larger diameter at an upper end. The wood core thus includes a cylindrical lateral surface and two ends which are generally flat. As discussed in detail above, it is desirable for the wood core 20 to be coated with an outer coating 30 of PTMEG or similar material to improve its performance, especially in the marine environment.

The outer surface of the wood core 20, when initially provided, has some degree of imperfections therein. These imperfections can include splinters, debris and checks (holes gouged out of the outer surface of the wood core). The outer coating 30 preferably has a smooth outer surface 38 and a bond 35 defining an inner surface of the outer coating 30 adjacent the outside of the wood core 20. This bond 35 is preferably a secure bond between the wood core 20 and the outer coating 30.

To keep the outer surface 38 smooth and to promote this secure bond 35, the outside of the wood core 20 is cleaned of any debris and any splinters are removed therefrom. Furthermore, a desirable moisture level for the wood core 20 is achieved before the process begins. If desired, the wood core 20 can be treated, such as with a pressure treating or other wood preservative, before applying the outer coating 30. Loose splinters are also removed. If large cracks or checks exist on the surface they are filled.

The outer coating 30 typically extends over the lateral sides of the wood core 20. End caps can be provided at ends of the wood core 20 to complete the encapsulation of the wood core 20, at least at an upper end thereof. This end cap, in one embodiment, is formed from a material compatible with or the same as PTMEG. The end cap can be prefabricated and attached to the end of the wood core 20 or can be applied thereto such as with a spraying technique. The process of this invention is primarily associated with the application of the outer coating 30 rather than the placement of the end caps.

The outer coating 30 has a thickness comprised of accumulation of multiple separate layers of PTMEG or similar material sprayed onto the outside of the wood core 20, building up this outer coating 30 to a desired thickness. In one embodiment a thickness of this coating is between one-half inch and one inch in thickness. Other thicknesses for the outer coating 30 could also be provided.

To support the wood core 20 during the application of the layers forming the outer coating 30, the wood core 20 is preferably oriented with a longitudinal axis extending approximately horizontally and resting upon a pair of the carriers 40, which provide a preferred form of roller support for the wood core 20. A pair of such carriers 40 are preferably provided spaced longitudinally from each other. Each carrier 40 includes a base with support wheels 44 extending upward therefrom. The support wheels 44 (also referred to as “rollers”) are rotatably supported upon axles 46 which are pivotably attached to upper ends of frames 48 extending upward from an upper surface of the base 42. Caster wheels 49 are preferably provided below the base 42 to allow the carrier 40 to roll upon an underlying horizontal surface.

The two support wheels 44 are preferably oriented within common planes and with their axles 46 parallel to each other and extending horizontally. A saddle space is thus provided between the two support wheels 44 into which the wood core 20 can rest. The wood core 20 can then be rotated relatively easily about a central longitudinal axis (along arrow B of FIG. 4). The caster wheels 49 are preferably lockable and unlockable so that the entire wood core 20 can be moved upon the carriers 40 in a variety of different directions when the caster wheels 49 are unlocked, but the caster wheels 49 can be locked when desired so that the carriers 40 are kept from moving and the wood core 20 is prevented from any movement other than rotation about the longitudinal axis (arrow B of FIG. 4).

To apply the outer coating 30, a spray head 50 is utilized. This spray head 50 can be any of a variety of different spray heads or similar devices which bring two separate components together, mix them together and spray them out of a tip 52 thereof. The particular spray head 50 disclosed herein has a tip 52 downstream from a mixer 54. A trigger 56 is manipulatable by a hand of the user to cause mixed PTMEG or similar material to be sprayed out of the tip 52 of the spray head 50 when the trigger 56 is depressed.

A pair of hoses 58 connect to the spray head 50 upstream of the mixer 54. These hoses 58 are preferably held together by a keeper 59 so that the two hoses 58 can be managed together. The hoses 58 extend to separate reservoirs and pumps which are preferably coordinated together so that they deliver a desired ratio of two separate materials along each hose 58. For instance, if the two components of the PTMEG or similar mixture are to be provided in a 1-to-1 ratio, the pumps are timed so that they deliver a common amount of flow rate through each hose 58. Preferably, the pumps and associated preparation equipment also includes heating apparatus so that the components supplied through the hoses 58 are not only pressurized but also heated to an optimal temperature. Curing of the PTMEG or similar material after being sprayed from the spray head 50 occurs by both cooling and reaction of the two components together. The resulting outer coating 30 has a consistency and hardness similar to a soft plastic or a hard rubber and which is non-porous.

In a preferred form of the invention, a squeegee 60 is provided particularly for working of the PTMEG or similar material after it is sprayed as a layer onto the wood core 20. The squeegee 60 preferably includes at least one handle 62 with a head 64 at a distal end of the handle 62 and with a blade 66 on the head 64. This blade 66 is preferably arcuate, most preferably with a curvature approximately similar to that of the outside of the wood core 20.

The squeegee 60 provides two functions. First, layers of PTMEG or similar material which are first applied to the wood core 20 benefit from being pressed into the outside of the wood core 20 so that the PTMEG extends into small cracks and other roughened surface features on the outside of the wood core 20 to provide a secure bond 35 between the outer coating 30 and the wood core 20. Later, the squeegee 60 can be utilized after a final layer of outer coating 30 has been sprayed onto the wood core 20 to provide a smooth outer surface for the outer coating 30. In one embodiment, the squeegee 60 can merely be a flexible piece of planar rubber which has been curved to have a desired curvature and is held in two hands to be run longitudinally with a flat edge curved to pass along the outside of the wood core 20 (along arrow A of FIG. 4).

In practicing the method of this invention, the wood core 20 is initially placed upon multiple carriers 40. A first layer of PTMEG or similar material is then sprayed from the spray head 50 (which has been prepped for supply under pressure of two different components to the mixer 54 from the hoses 58, and then discharged from the tip 52 of the spray head 50. A portion of the outside of the wood core 20 is sprayed with this material (along arrow C of FIG. 4) in the form of a spray S. A layer of PTMEG or similar material is applied to the outside of the wood core 20 from one end to the other. This spray path will only cover part of the radial lateral surface of the wood core 20. Thus, the wood core 20 is rotated (along arrow B of FIG. 4) and the spray process is continued to add another pass of spray material onto a surface of the wood core 20. Multiple passes (along arrow A) with the spray head 50, followed by multiple rotations (about arrow B of FIG. 4) results in a complete single layer of PTMEG or similar material being provided as part of the outer coating 30.

After at least one such layer has been applied, and most preferably after two such layers have been applied, the squeegee 60 is utilized (by passing along arrow A of FIG. 4) to press the PTMEG or similar material into the outside of the wood core 20 to form a tight bond 35. The squeegee 60 runs longitudinally (along arrow A) and then for convenience, the entire wood core 20 can be rotated (about arrow B) before further passage of the squeegee (along arrow A) until all surfaces of the wood core 20 have had the squeegee 60 applied thereto to press a layer of the outer coating 30 into the outside of the wood core 20.

The process of coating is then continued with the spray head 50 with both longitudinal motion of the spray head 50 (along arrow A of FIG. 4) interposed by rotation of the wood core 20 (about arrow B of FIG. 4) to apply successive additional layers of PTMEG or similar material. After about ten layers (and most preferably twelve layers) in total have been applied, all of the desired PTMEG or similar material has been applied to form the outer coating 30. A final finish of the outer surface 38 is prepared by running the squeegee 60 over the outer surface 38 once more to provide a desired surface finish. Most preferably, this surface finish is a smooth surface finish free of bubbles or other imperfections.

The coated piling 10 is complete and can be allowed to cool and finally cure. If multiple wood cores 20 are to be coated, the spray head 50 can be kept active by bringing a new wood core 20 located upon separate carriers 40 into position for treatment of a new wood core 20. After the last wood core 20 has been coated, a cleaning regimen is pursued with the spray head 50 and associated hoses 58 so that the spray head 50 and associated equipment including hoses 58 are ready for reuse in the future.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1. A process for coating an elongate wooden structure with PTMEG type material, including the steps of:
supporting the piling on at least two sets of parallel rollers and with a longitudinal axis oriented substantially horizontal;
cleaning an outer surface of the piling to remove splinters and debris;
filling or covering any large checks or cracks in the surface of the piling;
spraying PTMEG type material onto the surface of the piling from a first end to a second end, with rotation of the piling upon the rollers to entirely coat a cylindrical surface of the piling with a first layer of PTMEG type material;
repeating said spraying step to provide a second layer upon said first layer;
pressing a squeegee against the cylindrical surface of the piling after the PTMEG type material has been applied by said repeating step, to enhance a bond between the PTMEG type material and the surface of the piling;
applying further layers of PTMEG type material by repeating said spraying step after said pressing step; and
applying a squeegee in contact with a final layer of PTMEG type material to provide a desired surface finish.

2. The process of claim 1 wherein said supporting step includes each set of rollers having a base with roller support wheels rotatably supported upon axles positioned above the base.

3. The process of claim 2 wherein said supporting step includes the support wheels rolling freely on the axles rotatably supported above the base by a pair of frames on either side of each support wheel.

4. The process of claim 3 wherein said supporting step includes the base supported above a ground surface on caster wheels to allow the base to be moved about on a horizontal surface.

5. The process of claim 3 wherein a pair of the two sets of parallel rollers are provided which are spaced from each other longitudinally with the pilings resting upon each of the pairs of rollers.

6. The process of claim 1 wherein said applying further layers step includes at least ten total layers of PTMEG type material applied to the surface of the piling.

7. The process of claim 1 wherein said spring step includes preliminary steps of heating two parts of a mixture which when combined form the PTMEG type material, and mixing the two parts upstream of a spray head which sprays the PTMEG type material onto the piling.

8. The process of claim 1 wherein said pressing step includes pressing with a squeegee having an arcuate blade.

9. A method for coating an elongate structure, including the steps of:
supporting the elongate structure approximately horizontally;
spraying a coating onto a surface of the elongate structure to provide a first layer;
pressing the coating against the surface to enhance a bond between the surface and a coating first layer; and
spraying further layers of coating onto the surface.

10. The method of claim 9 including the further step of further working a final layer of coating to provide a desired surface finish.

11. The method of claim 10 wherein said further working step and said pressing step each involve use of a squeegee passing along a longitudinal axis of the elongate structure while pressing the squeegee against the coating.

12. The method of claim 11 wherein the squeegee of said further working step and said pressing step has an arcuate blade.

13. The method of claim 9 wherein said spraying step includes passing a tip of a spray head longitudinally between ends of the elongate structure, followed by a rotation of the elongate structure about a central axis thereof and further passing of the tip of the spray head between the ends of the elongate structure until an entire surface of the elongate structure between ends thereof has been provided with a layer of the coating.

14. The method of claim 13 wherein said supporting step includes supporting said elongate structure upon rollers which facilitate rotation of the elongate structure about a central axis thereof.

15. The method of claim 14 wherein said supporting step includes the rollers provided in at least two sets of at least two rollers per set, each set of rollers having a base with roller support wheels rotatably supported upon axles suspended above the base.

16. The method of claim 15 wherein said supporting step includes the support wheels rolling freely on the axles rotatably supported above the base by a pair of frames on either side of each support wheel;
wherein said supporting step includes said rollers supported above a ground surface on caster wheels to allow the base to be moved about on a horizontal surface; and
wherein a first set of parallel rollers and a second set of parallel rollers are provided which are spaced from each other longitudinally with the pilings resting upon each of the sets of rollers.

17. The method of claim 9 wherein said spraying steps include preliminary steps of heating two parts of a mixture which, when combined, form a PTMEG type material, and mixing the two parts upstream of a spray head which sprays the PTMEG type material as the coating onto the piling.

18. The method of claim 9 wherein said spraying step is preceded by the step of cleaning an outer surface of the elongate structure to remove splinters and debris therefrom.

19. The method of claim 18 wherein said cleaning step is followed by a step of filling or covering any large checks or cracks in the surface of the elongate structure.

20. A carrier for elongate objects, comprising in combination:
a first base having an upper surface and a lower surface, said upper surface opposite said lower surface;
a first pair of roller wheels rotatably supported by said first base above said upper surface;
said first pair of roller wheels oriented in planes substantially parallel with each other;
a second base having an upper surface and a lower surface, said second base upper surface opposite said second base lower surface;
a second pair of roller wheels rotatably supported by said second base above said upper surface thereof;
said second pair of roller wheels oriented in planes substantially parallel with each other; and
said first base and said second base spaced from each other by a distance greater than half of a length of an elongate object to be supported thereon, and with said first pair of roller wheels of said first base oriented substantially parallel with said second pair of roller wheels of said second base.

21. The carrier of claim 20 wherein said first pair of roller wheels are oriented within a common plane, and wherein said second pair of roller wheels are oriented in a common plane, said common plane for said first pair of roller wheels substantially parallel with said common plane for said second pair of roller wheels.

22. The carrier of claim 21 wherein each said roller wheel is supported upon an axle, said axles rotatably supported by frame elements extending up from one of said upper surfaces of one of said bases, each said axle having ends supported by separate frame elements, with said frame elements which support ends of said axles spaced apart by a distance greater than a width of said roller wheels supported by said axles.

23. The carrier of claim 22 wherein caster wheels are connected to lower surfaces of said first base and said second base.
